(19) United States
(12) Patent Application Publication
(10) Pub. No.: US 2026/0139796 A1
(43) Pub. Date: May 21, 2026

(54) COMPOSITE MATERIAL TANK WITH NEAT RESIN LINER

(71) Applicant: Blue Origin Manufacturing, LLC, Huntsville, AL (US)

(72) Inventor: Weidong Song, Woodinville, WA (US)

(21) Appl. No.: 18/952,762

(22) Filed: Nov. 19, 2024

(51) Int. Cl. F17C 1/16

(52) U.S. Cl. CPC F17C 1/16; F17C 2201/0104; F17C 2203/0604; F17C 2203/0624; F17C 2203/066; F17C 2203/0673; F17C 2209/2163; F17C 2209/232; F17C 2223/0161

(57) ABSTRACT

A tank and methods for manufacturing the tank are provided. In one aspect, the tank includes a cylindrical wall formed into a shape that matches a cylindrical mandrel. The cylindrical wall can include a neat resin layer having a plurality of consolidated neat resin films, and a thermoplastic composite material layer having a plurality of consolidated fiber-reinforced composite tape layers. At least one fiber-reinforced composite tape layer of the thermoplastic composite material layer can be consolidated with at least one neat resin film of the neat resin layer.

### BACKGROUND

### Field

The technology relates generally to tanks, and more specifically a cryogenic tank configured to store gas and/or liquid.

### Description of Related Art

Traditional propellant tanks for launch and space vehicles are typically made with heat resistant, strong metals, such as aluminum alloys, steels, or the like. Composite materials, such as thermoset composites or thermoplastic composites, are much lighter than the metals traditionally used for propellant tanks. However, when composite materials are subjected to thermal cycling, a mismatch of the coefficient of thermal expansion (CTE mismatch) between the resin matrix and fibers of the composite material can cause thermal stresses in the resin matrix. The thermal stresses can form microcracks in the resin matrix. The microcracks typically form at the interface between the fiber and the resin of the composite material. When subjected to subsequent thermal cycling, the microcracks can propagate through the composite material leading to leaking or other structural failures. Therefore, there exists a need for improvements to these and other drawbacks of traditional composite tanks.

### SUMMARY

Each embodiment disclosed herein has several aspects, no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing approaches to tanks configured to store cryogenic gas.

In accordance one aspect, a tank configured to store a cryogenic gas is provided. The tank includes a cylindrical wall. The cylindrical wall is formed into a shape that matches a cylindrical mandrel. The cylindrical wall includes a neat resin layer and a thermoplastic composite layer. The neat resin layer includes a plurality of consolidated neat resin films, and the thermoplastic composite material layer includes a plurality of consolidated fiber-reinforced composite tape layers. At least one fiber-reinforced composite tape layer is consolidated with at least one neat resin film.

In some embodiments, the at least one fiber-reinforced composite tape layer is consolidated with at least one neat resin film before another fiber-reinforced composite tape layer is consolidated with the at least one fiber-reinforced composite tape layer. In some embodiments, the at least one neat resin film is consolidated with the at least one fiber-reinforced composite tape layer before another neat resin film is consolidated with the at least one neat resin film. In some embodiments, a resin of the thermoplastic composite material layer includes a same resin as a resin of the neat resin layer. In some embodiments, a resin of the thermoplastic composite material layer includes a different resin as a resin of the neat resin layer. In some embodiments, the neat resin layer is an innermost layer of the cylindrical wall, and the thermoplastic composite material layer is an outermost layer of the cylindrical wall. In some embodiments, the innermost layer of the plurality of neat resin films is formed into a shape that matches the cylindrical mandrel, and the outermost layer of the plurality of neat resin films is consolidated with an innermost film of the plurality of fiber-reinforced composite tape layer. In some embodiments, the neat resin layer is an outermost layer of the cylindrical wall, and the thermoplastic composite material layer is an innermost layer of the cylindrical wall. In some embodiments, the innermost layer of the plurality of fiber-reinforced composite tape layers is formed into a shape that matches the cylindrical mandrel, and the outermost layer of the plurality of fiber-reinforced composite tape layers is consolidated with an innermost layer of the plurality of neat resin films. In some embodiments, the thermoplastic composite material layer is a first composite material layer, and wherein the cylindrical wall further includes a second composite material layer. In some embodiments, the second composite material layer includes a same composite material as the first composite material layer. In some embodiments, the second composite material layer includes a different composite material as the first composite material layer. In some embodiments, the neat resin layer is positioned between the first composite material layer and the second composite material layer. In some embodiments, the neat resin layer includes a thickness between 0.5 mm and 2 mm. In some embodiments, the thermoplastic composite material layer includes a thickness between 2.5 mm and 20.0 mm. In some embodiments, the composite material of the thermoplastic composite material layer includes polyether ether ketone (PEEK), polyetherketoneketone (PEKK), polyphenylene sulfide (PPS), or polyetherimide (PEI).

In another aspect, a method of manufacturing a tank on a mandrel is provided. The method includes forming a neat resin layer on the mandrel, forming a thermoplastic composite material layer on the mandrel, and consolidating the neat resin layer with the thermoplastic composite material layer. The tank is configured to store a cryogenic gas. Forming the neat resin layer includes applying a plurality of neat resin film layers and while applying each neat resin film layers of the plurality of neat resin film layers, consolidating each neat resin film layer with a previously applied neat resin film layer. Forming the thermoplastic composite material layer includes applying a plurality of fiber-reinforced composite tape layers on a first fiber-reinforced composite tape layer and while applying each fiber-reinforced composite tape layer of the plurality of fiber-reinforced composite tape layers, consolidating each fiber-reinforced composite tape layer with a previously applied fiber-reinforced composite tape layer.

In some embodiments, the neat resin layer and the thermoplastic composite material layer are consolidated on the mandrel. In some embodiments, the thermoplastic composite material layer is formed over the neat resin layer. In some embodiments, consolidating the neat resin layer and the thermoplastic composite material layer includes consolidating an innermost fiber-reinforced composite tape layer of the plurality of fiber-reinforced composite tape layers with an outermost neat resin film layer of the plurality of neat resin film layers. In some embodiments, the neat resin layer is formed over the thermoplastic composite layer. In some embodiments, consolidating the neat resin layer and the thermoplastic composite material layer includes consolidating an innermost neat resin film layer of the plurality of neat resin film layers with an outermost fiber-reinforced composite tape layer of the plurality of fiber-reinforced composite tape layers. In some embodiments, the thermoplastic composite layer is a first thermoplastic composite layer, and the method includes forming a second thermoplastic composite layer. In some embodiments, the method further includes consolidating the neat resin layer and the thermoplastic material layer so the neat resin layer is positioned between the first thermoplastic composite layer and the second thermoplastic composite layer. In some embodiments, an innermost fiber-reinforced composite tape layer of the second thermoplastic composite material layer is consolidated to an outermost neat resin film layer of the plurality of neat resin film layers.

### BRIEF DESCRIPTION OF THE DRAWINGS

The foregoing and other features of the present disclosure will become more fully apparent from the following description, taken in conjunction with the accompanying drawings. Understanding that these drawings depict only several embodiments in accordance with the disclosure and are not to be considered limiting of its scope, the disclosure will be described with additional specificity and detail through use of the accompanying drawings. The drawings are not necessarily drawn to scale, and some features may be enlarged while some features may be omitted for the sake of clarity. The relative dimensions and proportions as shown are not intended to limit the present disclosure.

In the drawings, similar symbols typically identify similar components, unless context dictates otherwise. Wherever possible, the same reference numbers will be used throughout the drawings to refer to the same or like parts. The illustrative embodiments described in the detailed description, drawings, and claims are not meant to be limiting. Other embodiments may be utilized, and other changes may be made without departing from the spirit or scope of the subject matter presented here. It will be readily understood that the aspects of the present disclosure, as generally described herein, and illustrated in the drawings, may be arranged, substituted, combined, and designed in a wide variety of different configurations, all of which are explicitly contemplated and make part of this disclosure.

FIG. 1 illustrates an embodiment of a tank according to the present disclosure.

FIG. 2 illustrates a perspective view of a cross-section of an embodiment of a wall of a tank according to the present disclosure.

FIG. 3A illustrates a portion of a wall of a tank with a neat resin inner layer and a composite material outer layer according to the present disclosure.

FIG. 3B illustrates a portion of another wall of a tank with a composite material inner layer and a neat resin outer layer according to the present disclosure.

FIG. 3C illustrates a portion of another wall of a tank with a neat resin layer between composite material layers according to the present disclosure.

FIG. 4A illustrates an embodiment of a system for manufacturing a tank according to the present disclosure.

FIG. 4B illustrates a schematic of the system of FIG. 4A placing a layer of material according to an embodiment of the present disclosure.

FIG. 5A illustrates a method of manufacturing the wall of FIG. 3A with the system of FIG. 4A according to an embodiment of the present disclosure.

FIG. 5B illustrates a method of manufacturing the wall of FIG. 3B with the system of FIG. 4A according to an embodiment of the present disclosure.

FIG. 5C illustrates a method of manufacturing the wall of FIG. 3C with the system of FIG. 4A according to an embodiment of the present disclosure.

### DETAILED DESCRIPTION

Embodiments of the present disclosure include devices, systems, and methods related to a composite material tank with a neat resin liner. The tanks and associated components described herein may be subjected to thermal cycling. The tanks may be used as a propellant tank for a launch vehicle or space vehicle. Tanks including or formed of composite materials can reduce or minimize the weight of the tanks and reduce the overall weight of the launch vehicle or space vehicle. In order to reduce or minimize the formation and/or propagation of microcracks through the walls of the tanks, the tanks according to the present disclosure may include a neat resin layer and a composite material layer. Embodiments of the composite material layer include a composite material including a plurality of fibers incorporated or integrated with a resin matrix. Embodiments of the neat resin layer include a neat resin that does not include a fiber or other components equivalent to a fiber. Since the neat resin layer does not include a fiber, the neat resin layer does not include an interface between a fiber and a resin matrix as is the case with a composite material. Accordingly, microcracks may not form in the neat resin layer according to embodiments of the present disclosure due to CTE mismatch between a fiber and a resin. Therefore, microcracks that may form in the composite material layer may not propagate through the neat resin layer. Advantageously, embodiments of tanks including a neat resin layer according to embodiments of the present disclosure may prevent or inhibit leaking of gas or liquid in the tank. In some advantageous embodiments, the resin of the neat resin layer may include the same resin as a resin of the composite material layer in order to ensure compatibility between the neat resin layer and the composite material layer during manufacturing and use of the tank.

Embodiments of the present disclosure are described with reference to tanks and components thereof that may be used as propellant tanks for launch vehicles and/or space vehicles, but it will be understood that embodiments of the present disclosure are not limited to this context and can be suitably implemented in any structure or container configured to store a liquid or a gas and may be subjected to thermal cycling. In addition, references to a resin throughout this disclosure will be understood to refer to a resin matrix or other material including one or more resins.

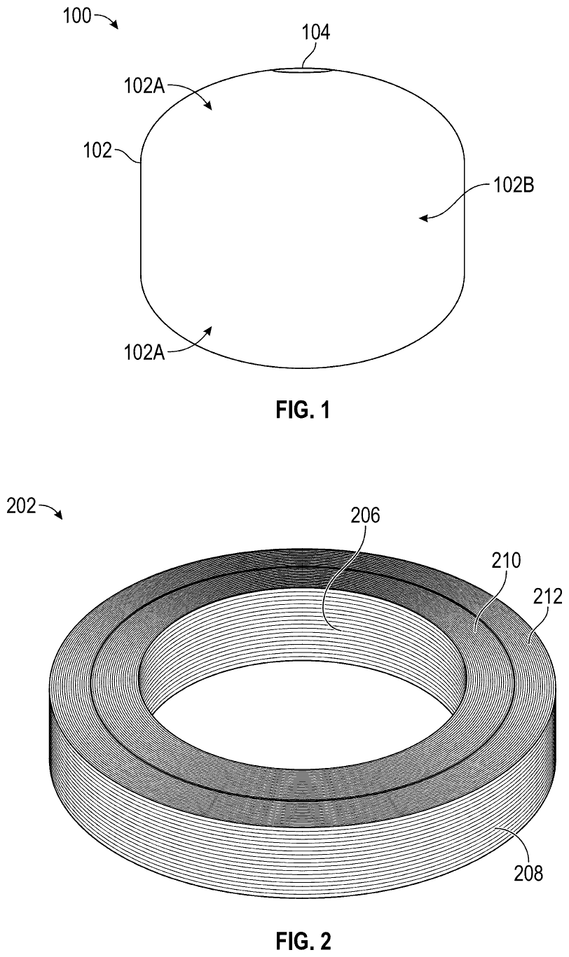

FIG. 1 illustrates an example embodiment of a tank 100 according to the present disclosure. The tank 100 may be configured to store a fluid, for example a gas and/or a liquid. The fluid may include a cryogenic gas and/or a cryogenic liquid. In some embodiments, the tank 100 may include a propellant tank for a rocket. The tank 100 may store propellant for a rocket engine.

The tank 100 includes one or more walls 102. The wall 102 may define an inner volume of the tank 100. In this non-limiting example, the tank 100 is a cylindrical-shaped tank. Other shapes can be suitably implemented, for example the tank 100 can be a spherical-shaped or prism-shaped tank. The wall 102 may have a cross-sectional shape that is a circle, an oval, an ellipse, a square, a rounded square, or a triangle. Other cross-sectional shapes can be suitably implemented. In this non-limiting example, the wall 102 is a cylindrical wall. The wall 102 may include end portions 102A and a middle portion 102B. The middle portion 102B may be between the end portions 102A. The end portions 102A may include a valve (for example, a port) 104. Gas and/or liquid may be added to and/or removed from the tank 100 via the valve 104.

FIG. 2 illustrates a perspective view of a cross-section of an embodiment of a wall 202 of a tank according to the present disclosure. The wall 102 of the tank 100 may include any of the features of the wall 202 and the wall 202 may include any of the features of the wall 102 of the tank 100. The wall 202 includes an inner surface 206 and an outer surface 208. The inner surface 206 may define an inner volume of the tank. In some examples, another surface inward of the inner surface 206 defines the inner volume of the tank. The wall 202 includes a neat resin layer 210 and a composite layer 212. An innermost surface of the neat resin layer 210 may define at least a portion of the inner surface 206. The neat resin layer 210 may extend between an innermost surface of the composite layer 212 and the inner volume of the tank. An outermost surface of the composite layer 212 may define at least a portion of the outer surface 208.

The neat resin layer 210 includes a neat resin (for example, a resin or a resin matrix having no or substantially no integrated or incorporated fiber(s)). The composite layer 212 includes a composite material. In some embodiments, the composite material of the composite layer 212 includes a resin and one or more fibers. The composite material may include a thermoplastic composite, a thermoset composite, and/or any other suitable composite material. In some embodiments, the composite material may include thermo polyether ether ketone (PEEK), polyetherketoneketone (PEKK), polyphenylene sulfide (PPS), polyetherimide (PEI), and/or any other thermoplastic composite. In this non-limiting embodiment, the composite layer 212 is a thermoplastic composite material layer 212.

In some embodiments, the wall 202 may be manufactured using automated fiber placement (AFP). The neat resin layer 210 may include a plurality of layers of neat resin film. The composite layer 212 may include a plurality of layers of composite tape. In some non-limiting embodiments, the plurality of layers of composite tape can include a plurality of fiber-reinforced composite tape layers. The plurality of layers of neat resin film of the neat resin layer 210 may be consolidated together. The plurality of layers of composite tape may be consolidated together. In some embodiments, a layer of the plurality of layers of the composite layer 212 may be consolidated with a layer of the plurality of layers of the neat resin layer 210. In one non-limiting example, a layer of the composite layer 212 may be consolidated with a layer of the neat resin layer 210 such that the layer of the composite layer 212 and the layer of the neat resin layer 210 are integrated together into one single layer, where an interface between the layer of the composite layer 212 and the layer of the neat resin layer 210 is indistinguishable in the one single layer at a molecular level. In some embodiments, the plurality of layers of neat resin film of the neat resin layer 210 may be autohesion-bonded together. In some embodiments, the plurality of layers of composite tape may be autohesion-bonded together. In some embodiments, a layer of the plurality of layers of the composite layer 212 may be autohesion-bonded with a layer of the plurality of layers of the neat resin layer 210. In one non-limiting example, a layer of the composite layer 212 may be autohesion-bonded with a layer of the neat resin layer 210 by heating the layer of the composite layer 212 and the layer of the neat resin layer 210 such that the layer of the composite layer 212 and the layer of the neat resin layer 210 are directly bonded together.

In some embodiments, the wall 202 may be manufactured using a mandrel. For example, a first layer of material forming the wall 202 may be placed on a mandrel, a second layer of material forming the wall 202 may be placed on the first layer, and the second layer may be consolidated and/or autohesion-bonded with the first layer. By a first feature such as a layer, a level or other structure, being formed “on” “(or being placed “on” or laid “on”) a second feature such as a layer, a level or other structure, is hereby meant that the first feature may be formed directly on the second feature, that is, in abutment with the second feature, or with one or more layers or structures intermediate the first and the second feature, that is, not in direct contact with the second feature, unless explicitly stated otherwise. In some examples, the mandrel can be a cylindrical mandrel.

In some examples, a cross-sectional shape of the mandrel can be a circle, an oval, an ellipse, a square, a rounded square, or a triangle. The shape of the wall 202 can match a shape of the mandrel. For example, the wall 202 can be formed into a cylindrical shape that matches a cylindrical shape of the mandrel. In some embodiments, the plurality of layers of neat resin film of the neat resin layer 210 may be consolidated and/or autohesion bonded together on the mandrel. In some embodiments, the plurality of layers of composite tape may be consolidated and/or autohesion-bonded together on the mandrel. In some embodiments, a layer of the plurality of layers of the composite layer 212 may be consolidated and/or autohesion-bonded together with a layer of plurality of layers of the neat resin layer 210 on the mandrel. In some examples of the present disclosure, a plurality of the layers of the wall 202 are consolidated and/or autohesion-bonded on the mandrel (for example, full in-situ consolidation). In some non-limiting embodiments, a first layer (for example, a layer of the plurality of layers of the composite layer 212) can be consolidated with a second layer (for example, a layer of the plurality of layers of the neat resin layer 210) by applying heat and pressure to combine the first and second layer into a single monolithic structure.

In some embodiments, cracks (for example, microcracks) may form in the composite layer 212. The resin of the composite material of the composite layer 212 may include a first coefficient of thermal expansion (CTE) and the fiber integrated or incorporated in the resin of the composite material of the composite layer 212 may include a second CTE. The first CTE may be a different CTE than the second CTE (that is, there may be a CTE mismatch between the materials). When the wall 202 is subjected to thermal cycling (for example, an increase and/or decrease in temperature) the resin of the composite material of the composite layer 212 may expand and/or contract at a different rate than the fiber of the composite material of the composite layer 212. Cracks may form in the composite layer 212 due to the different rates of expansion and/or contraction of the resin of the composite material of the composite layer 212 and the fiber of the composite material of the composite layer 212. The cracks may propagate in the composite layer 212 when a force is applied to the wall 202 and/or when the wall 202 is subjected to subsequent thermal cycling. The cracks may propagate entirely through the composite layer 212 between a first side and an opposing second side of the composite layer. Alternatively, the cracks may propagate partially through the composite layer 212. A force applied to the wall 202 can be a thermal load applied to the wall 202 when a temperature of the wall 202 changes, such as when the wall 202 is subjected to thermal cycling, and/or an external load applied to the wall 202. In some non-limiting examples, the external load can be an aerodynamic load, an inertial load, a pressure load, and/or any other similar load applied to the wall 202.

In some embodiments, the composite layer 212 may be a structural layer of the wall 202 and the neat resin layer 210 may not be a structural layer of the wall 202. In one non-limiting example, the composite layer 212 is configured to maintain a structural integrity of the wall 202 by absorbing loads applied to the wall 202, while the neat resin layer 210 is not configured to maintain a structural integrity of the wall 202 when a load is applied to the wall 202. The neat resin layer 210 may be a liner. The neat resin layer 210 can be configured to function as a barrier to cracks in the wall 202. In some embodiments, the neat resin layer 210 may prevent or inhibit propagation of cracks in and/or through the wall 202. A weakest point of a composite material may include an interface between one or more fibers of the composite material and a resin of the composite material. As described above, the neat resin layer 210 may include only a resin and/or a resin matrix having no or substantially no integrated or incorporated fiber(s). Accordingly, the entire neat resin layer 210 may be formed of materials that have a same CTE, or substantially the same CTE. When the wall 202 is subjected to thermal cycling (for example, an increase and/or decrease in temperature) material that forms the neat resin layer 210 may expand and/or contract at a same rate. Advantageously, cracks may not form (or be substantially inhibited or prevented from forming) in the neat resin layer 210 due to the absence of a CTE mismatch. Additionally, cracks that may form in the composite layer 212 may not propagate into the neat resin layer 210. The neat resin layer 310 may prevent or inhibit a gas and/or a liquid in the tank from leaking through the cracks that may form in the composite layer 312.

In some embodiments, a resin of the neat resin layer 210 may be different than a resin of the composite material of the composite layer 212. For example, the resins may have different compositions and/or material properties. In some embodiments, a resin of the neat resin layer 210 may be the same or substantially the same as a resin of the composite material of the composite layer 212. A neat resin layer 210 and a composite material of the composite layer 212 including a same resin according to embodiments of the present disclosure may simplify manufacturing and ensure compatibility (for example, CTE compatibility) between the resin of the neat resin layer 210 and the resin of the composite material of the composite layer 212. In embodiments of the present disclosure including a neat resin layer 210 and a composite layer 212 including a same resin, the resin of the neat resin layer 210 and the resin of the composite layer 212 can include a same CTE. In embodiments of the present disclosure, a neat resin layer 210 and a composite layer 212 that include a same resin may reduce or minimize separation of the composite layer 212 from the neat resin layer 210, for example during thermal cycling.

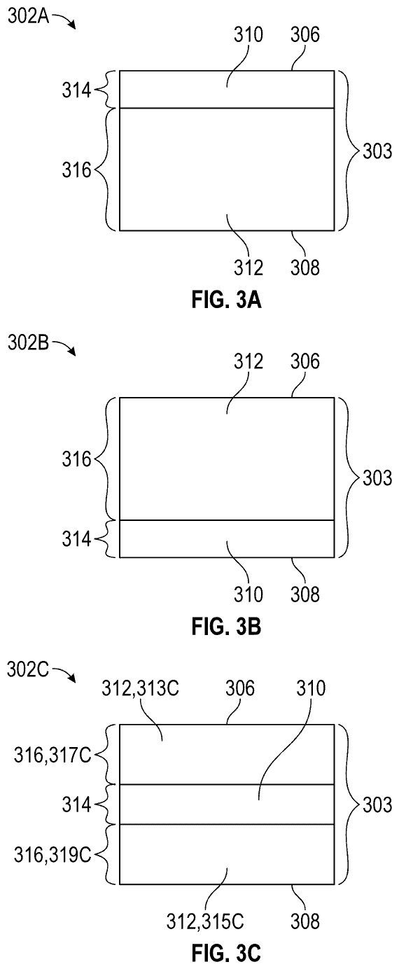

FIGS. 3A-3C illustrate a portion of walls 302A, 302B, 302C of a tank. The wall 102 of the tank 100 and the wall 202 may include any of the features of walls 302A, 302B, 302C and the walls 302A, 302B, 302C may include any of the features of the wall 102 of the tank 100 and the wall 202. As shown in FIG. 3A-3C, the walls 302A, 302B, 302C may extend between a first surface 306 and a second surface 308. The first surface 306 may include or define at least a portion of an inner surface of the walls 302A, 302B, 302C. The second surface 308 may include or define at least a portion of an outer surface of the walls 302A, 302B, 302C. The first surface 306 may define at least a portion of an inner volume of the tank. In some examples, another surface inward of the first surface 306 defines at least a portion of the inner volume of the tank. The second surface 308 may define at least a portion of an outer surface of the tank.

As shown in FIG. 3A, in some embodiments, the wall 302A may include a neat resin layer 310 and a composite layer 312. The composite layer 312 can include a thermoplastic composite material layer 312. In some embodiments, an innermost surface of the neat resin layer 310 may define at least a portion of the first surface 306. Accordingly, the neat resin layer 310 may include an innermost layer of the wall 302A. The neat resin layer 310 may extend between an innermost surface of the composite layer 312 and the inner volume of the tank. The neat resin layer 310 may prevent or inhibit a gas and/or a liquid in the tank from leaking through cracks that may form in the composite layer 312 of the wall 302A. In some embodiments, an outermost surface of the composite layer 312 may define at least a portion of the second surface 308. Accordingly, the composite layer 312 may include an outermost layer of the wall 302A. The composite layer 312 may protect the neat resin layer 310 from the environment around the wall 302A, for example, by absorbing loads applied to the wall 302A.

As shown in FIG. 3B, in some embodiments, the wall 302B may include the neat resin layer 310 and the composite layer 312. In some embodiments, an innermost surface of the composite layer 312 may define at least a portion of the first surface 306. Accordingly, the composite layer 312 may include an innermost layer of the wall 302B. The composite layer 312 may extend between an innermost surface of the neat resin layer 310 and the inner volume of the tank. In some embodiments, an outermost surface of the neat resin layer 310 may define at least a portion of the second surface 308. Accordingly, the neat resin layer 310 may include an outermost layer of the wall 302B. The neat resin layer 310 may prevent or inhibit a gas and/or a liquid in the tank from leaking through cracks that may form in the composite layer 312 of the wall 302B.

As shown in FIG. 3C, in some embodiments, the wall 302C may include the neat resin layer 310 and the composite layer 312. In some embodiments, the composite layer 312 may include a first composite layer 313C and a second composite layer 315C. The resin layer 310 may be positioned between the first composite layer 313C and the second composite layer 315C. In some embodiments, an innermost surface of the first composite layer 313C may define at least a portion of the first surface 306. Accordingly, the first composite layer 313C may include an innermost layer of the wall 302C. The first composite layer 313C may extend between an innermost surface of the neat resin layer 310 and the inner volume of the tank. The neat resin layer 310 may extend between an outermost surface of the first composite layer 313C and an innermost surface of the second composite layer 315C. Accordingly, the neat resin layer 310 may include a middle layer of the wall 302C. The neat resin layer 310 may prevent or inhibit a gas and/or a liquid in the tank from leaking through cracks that may form in the composite layer 312 of the wall 302C. In some embodiments, the second composite layer 315C may define at least a portion of the second surface 308. Accordingly, the second composite layer 315C may include an outermost layer of the wall 302C. The second composite layer 315C may protect the neat resin layer 310 from the environment around the wall 302C, for example, by absorbing loads applied to the wall 302C.

The neat resin layer 310 has a thickness 314 and the composite layer 312 has a thickness 316. As shown in FIG. 3A, the thickness 314 of the neat resin layer 310 of the wall 302A can be a distance between the first surface 306 and an outermost surface of the neat resin layer 310. The thickness 316 of the composite layer 312 of the wall 302A can be a distance between an innermost surface of the composite layer 312 and the second surface 308.

As shown in FIG. 3B, the thickness 314 of the neat resin layer 310 of the wall 302B can be a distance between an innermost surface of the neat resin layer 310 and the second surface 308. The thickness 316 of the composite layer 312 of the wall 302B can be a distance between the outermost surface of the composite layer 312 and the first surface 306.

In some embodiments, the thickness 316 of the composite layer 312 can be a distance greater than a distance of the thickness 314 of the neat resin layer 310. In some embodiments, the thickness 316 of the composite layer 312 may include a distance equal to a distance of the thickness 314 of the neat resin layer 310.

As shown in FIG. 3C, the first composite layer 313C has a thickness 317C and the second composite layer 315C has a thickness 319C. The thickness 316 of the composite layer 312 can be a sum of the thickness 317C of the first composite layer 313C and the thickness 319C of the second composite layer 315C. The thickness 317C of the first composite layer 313C can be a distance between the first surface 306 and an outermost surface of the first composite layer 313C. The thickness 319C of the second composite layer 315C can be a distance between an innermost surface of the second composite layer 315C and the second surface 308. The thickness of the neat resin layer 310 can be a distance between an innermost surface of the neat resin layer 310 and an outermost surface of the neat resin layer 310. In some embodiments, the thickness 317C of the first composite layer 313C can be a distance greater than a distance of the thickness 319C of the second composite layer 315C. In some embodiments, the thickness 319C of the second composite layer 315C can be a distance greater than a distance of the thickness 317C of the first composite layer 313C. In some embodiments, the thickness 317C of the first composite layer 313C can be a distance equal to a distance of the thickness 319C of the second composite layer 315C.

In some embodiments, the thickness 314 of the neat resin layer 310 may be selected in order to reduce or minimize a weight of the walls 302A, 302B, 302C and/or the tank. In some embodiments, the thickness 314 of the neat resin layer 310 may be selected so the neat resin layer 310 is sufficiently thick to prevent or inhibit propagation of microcracks through the walls 302A, 302B, 302C. In some embodiments, the thickness 314 of the neat resin layer 310 may be about 0.1 mm, about 0.2 mm, about 0.3 mm, about 0.4 mm, about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5, about 2.1 mm, about 2.2 mm, about 2.3 mm, about 2.4 mm, about 2.5 mm, about 2.6 mm, about 2.7 mm, about 2.8 mm, about 2.9 mm, about 3 mm, about 3.1 mm, about 3.2 mm, about 3.3 mm, about 3.4 mm, about 3.5 mm, and/or any value between the aforementioned values. In some embodiments, the thickness 314 of the neat resin layer 310 is about 0.5 mm and about 2.0 mm.

In some embodiments, the thickness 316 of the composite layer 312 may be selected so the composite layer 312 may withstand forces during use without deforming or breaking. In some embodiments, the thickness 316 of the composite layer 312 may be about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10.0 mm, about 10.5 mm, about 11.0 mm, about 11.5 mm, about 12.0 mm, about 12.5 mm, about 13.0 mm, about 13.5 mm, about 14.0 mm, about 14.5 mm, about 15.0 mm, about 15.5 mm, about 16.0 mm, about 16.5 mm, about 17.0 mm, about 17.5 mm, about 18.0 mm, about 18.5 mm, about 19.0 mm, about 19.5 mm, about 20.0 mm, about 20.5 mm, about 21.0 mm, about 21.5 mm, about 22.0 mm, about 22.5 mm, about 23.0 mm, about 23.5 mm, about 24.0 mm, about 24.5 mm, about 25.0 mm, about 25.5 mm, about 26.0 mm, about 26.5 mm, about 27.0 mm, about 27.5 mm, about 28.0 mm, about 28.5 mm, about 29.0 mm, about 29.5 mm, about 30.0 mm, and/or any value between the aforementioned values. In some embodiments, the thickness 316 of the composite layer 312 may be a distance between about 2.5 mm and about 20.0 mm. In some embodiments, the thickness 316 of the composite layer 312 may be a distance between about 2.5 mm and about 5.0 mm. In some embodiments, the thickness 316 of the composite layer 312 may be a distance between about 10.0 mm and about 20.0 mm.

In some embodiments, the thickness 314 of the neat resin layer 310 and/or the thickness 316 of the composite layer 312 may be constant throughout the walls 302A, 302B, 302C and/or the tank. In some embodiments, the thickness 314 of the neat resin layer 310 and/or the thickness 316 of the composite layer 312 may vary throughout the walls 302A, 302B, 302C and/or the tank.

With reference to FIG. 3C, in some embodiments, the thickness 317C of the first composite layer 313C of the wall 302C and/or the thickness 319C of the second composite layer 315C of the walls 302C may be constant throughout the wall 302C and/or the tank. In some embodiments, the thickness 317C of the first composite layer 313C of the wall 302C and/or the thickness 319C of the second composite layer 315C of the walls 302C may vary throughout the wall 302C and/or the tank.

The walls 302A, 302B, 302C have a thickness 303. In some embodiments, the thickness 303 of the walls 302A, 302B, 302C may be a distance between the first surface 306 and the second surface 308. In some embodiments, the thickness 303 of the walls 302A, 302B, 302C may be constant throughout the walls 302A, 302B, 302C and/or the tank. In some embodiments, the thickness 303 of the walls 302A, 302B, 302C may vary throughout the walls 302A, 302B, 302C and/or the tank.

It is to be appreciated that although walls 302A, 302B, 302C are illustrated as including only one neat resin layer 310, in some embodiments, the walls 302A, 302B, 302C may include multiple neat resin layers 310. For example, the walls 302A, 302B, 302C may include two or more neat resin layers 310 with a composite layer 312 between each neat resin layer 310. In some embodiments, the walls 302A, 302B, 302C may include two (2) neat resin layers 310, three (3) neat resin layers 310, four (4) neat resin layers 310, five (5) neat resin layers 310, six (6) neat resin layers 310, seven (7) neat resin layers 310, eight (8) neat resin layers 310, nine (9) neat resin layers 310, and/or ten (10) neat resin layers 310.

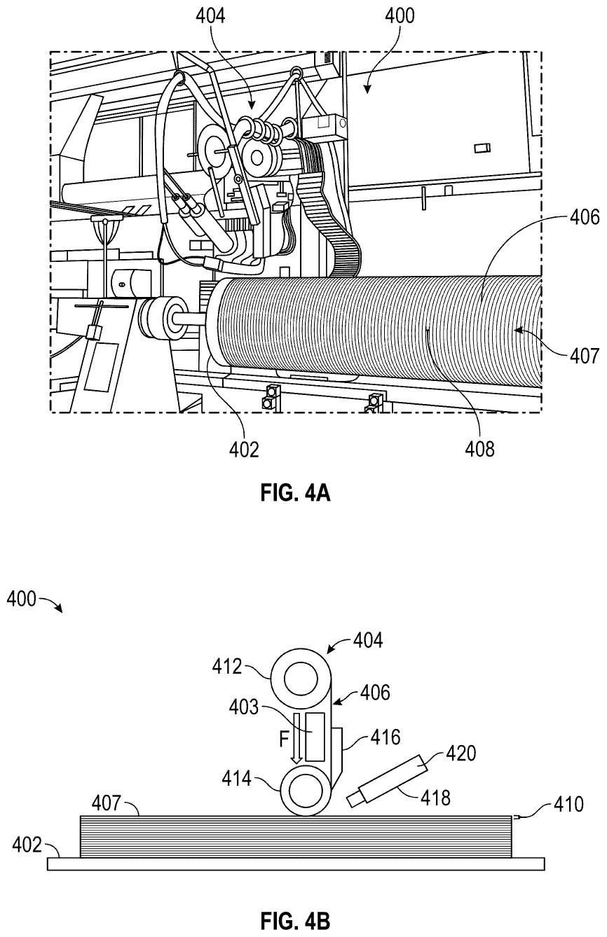

FIGS. 4A and 4B illustrate a system 400 for manufacturing a tank, such as the tank 100. As shown in FIG. 4A, the system 400 may include a mandrel 402 and a placement machine 404. The mandrel 402 in this example is a cylindrical mandrel. The placement machine 404 may apply material on the mandrel 402. The material may include a neat resin and/or a composite material, such as the neat resin of neat resin layer 310 and/or the composite material of the composite layers 312, 313C, 315C. The placement machine 404 may apply a plurality of tows 406 of the material on the mandrel 402. In some embodiments, the placement machine 404 may apply a plurality of tows 406 simultaneously. The tows 406 may include a strip (for example, tape or film) of the material. The tows 406 have a width 408. The width of the tows 406 may be a distance of about 0.20 in, about 0.25 in, about 0.30 in, about 0.35 in, about 0.40 in, about 0.45 in, about 0.50 in, about 0.55 in, about 0.60 in, about 0.65 in, about 0.70 in, about 0.75 in, about 0.80 in, about 0.85 in, about 0.90 in, about 0.95 in, about 1.00 in, and/or any value between the aforementioned values. As shown in FIG. 4B, the tows 406 have a thickness 410. The thickness 410 may be a distance of about 0.001 in, about 0.002 in, about 0.003 in, about 0.004 in, about 0.005 in, about 0.006 in, about 0.007 in, about 0.008 in, about 0.009 in, about 0.010 in, about 0.011 in, about 0.012 in, about 0.013 in, about 0.014 in, about 0.015, and/or any value between the aforementioned values.

In the non-limiting embodiment illustrated in FIG. 4B, the placement machine 404 is configured to apply a plurality of layers 407 of the material on the mandrel 402. The placement machine 404 includes a material feed 412, a roller 414, a guide 416, and a heat source 418. The material feed 412 is configured to feed one or more tows 406 of material to the roller 414. The guide 416 is configured to direct the one or more tows 406 of material toward the roller 414. The roller 414 may roll along the mandrel 402 and/or a previously applied layer 407 of material. The roller 414 may apply the one or more tows 406 of the material to the mandrel 402 and/or the previously applied layer 407 of material as the roller 414 rolls along the mandrel 402 and/or the previously applied layer 407 of material. The roller 414 may apply a force F (for example, pressure) to the one or more tows 406 as the roller 414 applies the one or more tows 406 to the mandrel 402 and/or the previously applied layer 407 of material. In some embodiments, the placement machine 404 may include a force assembly 403. The force assembly 403 may be configured to generate the force F.

The heat source 418 may be configured to melt the one or more tows 406 of the material and/or the previously applied layer 407 of the material. The heat source 418 may include a laser, a variable spot size (VSS) laser, and/or any other heat source suitable for melting the material. The heat source 418 may be positioned so the heat source 418 heats and/or melts the one or more tows 406 before the one or more tows 406 are applied to the mandrel 402 and/or the previously applied layer 407 of the material. The heat source 418 may be positioned so the heat source 418 melts a portion of the previously applied layer 407 in front of the roller 414 and/or beneath the roller 414. Accordingly, the heat source 418 may be configured to melt a portion of the previously applied layer 407 where a corresponding melted tow 406 will be placed.

The heat source 418 may include one or more heaters 420. The heat source 418 may include a heater 420 for each tow 406 of the one or more tows 406. Accordingly, each heater 420 may be configured to melt a corresponding tow 406 and/or a corresponding portion of the previously applied layer 407 of the material where the corresponding tow 406 will be applied.

As described above, the roller 414 may apply a force F to the one or more tows 406. The force F applied by the roller 414 may press the melted one or more tows 406 and the melted corresponding portions of the previously applied layer 407 together. The force F applied by the roller 414 may reduce or minimize voids between the one or more tows 406 and the previously applied layer 407. The roller 414 and/or placement machine 404 may consolidate the one or more tows 406 with the previously applied layer 407. Accordingly, the placement machine 404 may consolidate each subsequent layer 407 (for example, the one or more tows 406) with the previously applied layer 407 in order to consolidate the plurality of layers 407 together (for example, via autohesion). The placement machine 404 may consolidate the plurality of layers 407 together on the mandrel 402 (that is, in situ consolidation).

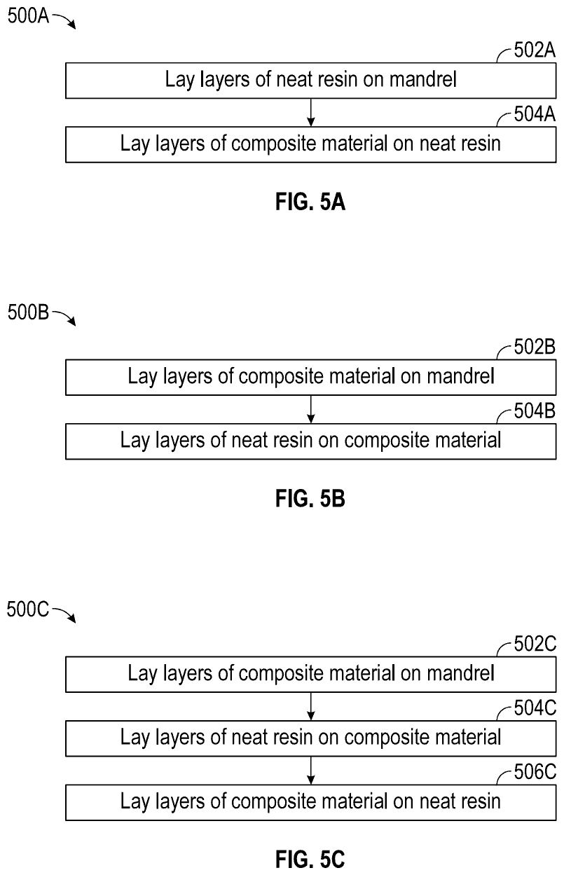

FIGS. 5A-5C illustrate methods 500A, 500B, 500C of manufacturing or forming walls 302A, 302B, 302C of a tank using the placement machine 404 according to an embodiment of the present disclosure. As shown in FIG. 5A, at step 502A of method 500A, one or more layers of neat resin material may be placed on the mandrel 402. The one or more layers of neat resin material may be laid on the mandrel 402. The one or more layers of neat resin material may include one or more layers of neat resin film. The one or more layers of neat resin material may form the neat resin layer 310 of the wall 302A. The one or more layers of neat resin material may be placed on the mandrel 402 with the placement machine 404. A first (for example, innermost) layer of neat resin material may be placed on the mandrel 402 and subsequent layers of the neat resin material may be placed on the previously applied layer of neat resin material. In this example, the innermost layer of the one or more layers of neat resin material is a neat resin film that is formed into a shape that matches the cylindrical mandrel 402. The heat source 418 of the placement machine 404 may melt tows 406 of the neat resin film and the previously applied layer of neat resin film. The roller 414 may apply a force to the tows 406 of the neat resin film and the previously applied layer of neat resin film to consolidate the tows 406 of the neat resin film with the previously applied layer of the neat resin film.

At step 504A, one or more layers of composite material may be placed on the neat resin layer 310 of the wall 302A. The one or more layers of composite material may be laid on the neat resin layer 310. The one or more layers of composite material may include one or more layers of composite tape. The one or more layers of composite material may form the composite material layer 312 of the wall 302A. The one or more layers of composite material may be placed on the neat resin layer 310 with the placement machine 404. A first (for example, innermost) layer of composite material may be placed on the neat resin layer 310 and subsequent layers of the composite material may be placed on the previously applied layer of composite material. The heat source 418 of the placement machine 404 may melt tows 406 of the composite tape and the previously applied layer of material. When the first layer of composite material is placed on the neat resin layer 310, the heat source 418 may melt the tows 406 of the composite tape and the last (for example, outermost) applied layer of neat resin film. The roller 414 may apply a force to the tows 406 of the composite tape and the last applied layer of neat resin film to consolidate the one or more tows 406 of the composite tape with the last applied layer of neat resin film and/or the neat resin layer 310. When subsequent layers of the composite material are placed, the heat source 418 may melt the tows 406 of the composite tape and the previously applied layer of composite tape. The roller 414 may apply a force to the tows 406 of the composite tape and the previously applied layer of composite tape to consolidate the tows 406 of the composite tape with the previously applied layer of composite tape.

As shown in FIG. 5B, at step 502B of method 500B, one or more layers of composite material may be placed on the mandrel 402. The one or more layers of composite material may be laid on the mandrel 402. The one or more layers of composite material may include one or more layers of composite material tape. The one or more layers of composite material may form the composite layer 312 of the wall 302B. The one or more layers of composite material may be placed on the mandrel 402 with the placement machine 404. A first (for example, innermost) layer of composite material may be placed on the mandrel 402 and subsequent layers of the composite material may be placed on the previously applied layer of composite material. In this example, the innermost layer of the one or more layers of composite material is a fiber-reinforced composite tape layer that is formed into a shape that matches the cylindrical mandrel 402. The heat source 418 of the placement machine 404 may melt tows 406 of the composite material tape and the previously applied layer of composite material tape. The roller 414 may apply a force to the tows 406 of the composite material tape and the previously applied layer of composite material tape to consolidate the tows 406 of the composite material tape with the previously applied layer of the composite material tape.

At step 504B, one or more layers of neat resin material may be placed on the composite layer 312 of the wall 302B. The one or more layers of neat resin material may be laid on the composite layer 312. The one or more layers of neat resin material may include one or more layers of neat resin film. The one or more layers of neat resin may form the neat resin layer 310 of the wall 302B. The one or more layers of neat resin material may be placed on the composite layer 312 with the placement machine 404. A first (for example, innermost) layer of neat resin may be placed on the composite layer 312 and subsequent layers of the neat resin material may be placed on the previously applied layer of neat resin material. The heat source 418 of the placement machine 404 may melt tows 406 of the neat resin film and the previously applied layer of material. When the first layer of neat resin material is placed on the composite layer 312, the heat source 418 may melt the tows 406 of the neat resin film and the last (for example, outermost) applied layer of composite material tape. The roller 414 may apply a force to the tows 406 of the neat resin film and the last applied layer of composite material tape to consolidate the one or more tows 406 of the neat resin with the last applied layer of composite material tape and/or the composite layer 312. When subsequent layers of the neat resin material are placed, the heat source 418 may melt the tows 406 of the neat resin film and the previously applied layer of neat resin film. The roller 414 may apply a force to the tows 406 of the neat resin film and the previously applied layer of neat resin film to consolidate the tows 406 of the neat resin film with the previously applied layer of neat resin film.

As shown in FIG. 5C, at step 502C of method 500C, one or more layers of composite material may be placed on the mandrel 402. The one or more layers of composite material may be laid on the mandrel 402. The one or more layers of composite material may include one or more layers of composite material tape. The one or more layers of composite material may form the first composite layer 313C of the wall 302C. The one or more layers of composite material may be placed on the mandrel 402 with the placement machine 404. A first (for example, innermost) layer of composite material may be placed on the mandrel 402 and subsequent layers of the composite material may be placed on the previously applied layer of composite material. The heat source 418 of the placement machine 404 may melt tows 406 of the composite material tape and the previously applied layer of composite material tape. The roller 414 may apply a force to the tows 406 of the composite material tape and the previously applied layer of composite material tape to consolidate the tows 406 of the composite material tape with the previously applied layer of the composite material tape.

At step 504C, one or more layers of neat resin material may be placed on the first composite layer 313C of the wall 302C. The one or more layers of neat resin material may be laid on the first composite layer 313C. The one or more layers of neat resin material may include one or more layers of neat resin film. The one or more layers of neat resin may form the neat resin layer 310 of the wall 302C. The one or more layers of neat resin material may be placed on the first composite layer 313C with the placement machine 404. A first (for example, innermost) layer of neat resin may be placed on the first composite layer 313C and subsequent layers of the neat resin material may be placed on the previously applied layer of neat resin material. The heat source 418 of the placement machine 404 may melt tows 406 of the neat resin film and the previously applied layer of material. When the first layer of neat resin material is placed on the first composite layer 313C, the heat source 418 may melt the tows 406 of the neat resin film and the last (for example, outermost) applied layer of composite material tape. The roller 414 may apply a force to the tows 406 of the neat resin film and the last applied layer of composite material tape to consolidate the one or more tows 406 of the neat resin with the last applied layer of composite material tape and/or the first composite layer 313C. When subsequent layers of the neat resin material are placed, the heat source 418 may melt the tows 406 of the neat resin film and the previously applied layer of neat resin film. The roller 414 may apply a force to the tows 406 of the neat resin film and the previously applied layer of neat resin fil to consolidate the tows 406 of the neat resin film with the previously applied layer of neat resin film.

At step 506C, one or more layers of composite material may be placed on the neat resin layer 310 of the wall 302C. The one or more layers of composite material may be laid on the neat resin layer 310. The one or more layers of composite material may include one or more layers of composite tape. The one or more layers of composite material may form the second composite layer 315C of the wall 302C. The one or more layers of composite material may be placed on the neat resin layer 310 with the placement machine 404. A first (for example, innermost) layer of composite material may be placed on the neat resin layer 310 and subsequent layers of the composite material may be placed on the previously applied layer of composite material. The heat source 418 of the placement machine 404 may melt tows 406 of the composite tape and the previously applied layer of material. When the first layer of composite material is placed on the neat resin layer 310, the heat source 418 may melt the tows 406 of the composite tape and the last (for example, outermost) applied layer of neat resin film. The roller 414 may apply a force to the tows 406 of the composite tape and the last applied layer neat resin film to consolidate the one or more tows 406 of the composite tape with the last applied layer of neat resin film and/or the neat resin layer 310. When subsequent layers of the composite material are placed, the heat source 418 may melt the tows 406 of the composite tape and the previously applied layer of composite tape. The roller 414 may apply a force to the tows 406 of the composite tape and the previously applied layer of composite tape to consolidate the tows 406 of the composite tape with the previously applied layer of composite tape.

Various modifications to the implementations described in this disclosure will be readily apparent to those skilled in the art, and the generic principles defined herein may be applied to other implementations without departing from the spirit or scope of this disclosure. Thus, the disclosure is not intended to be limited to the implementations shown herein but is to be accorded the widest scope consistent with the claims, the principles and the novel features disclosed herein. The word “example” is used exclusively herein to mean “serving as an example, instance, or illustration.” Any implementation described herein as “example” is not necessarily to be construed as preferred or advantageous over other implementations, unless otherwise stated.

Reference in this specification to “one embodiment,” “an embodiment,” or “in some embodiments” means that a particular feature, structure, or characteristic described in connection with the embodiment is included in at least one embodiment of the present disclosure. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described as such. Additionally, other implementations are within the scope of the present disclosure. In some cases, the actions recited in the claims may be performed in a different order and still achieve desirable results.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1. A tank configured to store a cryogenic gas, the tank comprising:
a cylindrical wall formed into a shape that matches a cylindrical mandrel, the cylindrical wall comprising
a neat resin layer comprising a plurality of consolidated neat resin films, and
a thermoplastic composite material layer comprising a plurality of consolidated fiber-reinforced composite tape layers, at least one fiber-reinforced composite tape layer consolidated with at least one neat resin film.

2. The tank of claim 1, wherein the at least one fiber-reinforced composite tape layer is consolidated with at least one neat resin film before another fiber-reinforced composite tape layer is consolidated with the at least one fiber-reinforced composite tape layer.

3. The tank of claim 1, wherein the at least one neat resin film is consolidated with the at least one fiber-reinforced composite tape layer before another neat resin film is consolidated with the at least one neat resin film.

4. The tank of claim 1, wherein a resin of the thermoplastic composite material layer comprises a same resin as a resin of the neat resin layer.

5. The tank of claim 1, wherein a resin of the thermoplastic composite material layer comprises a different resin as a resin of the neat resin layer.

6. The tank of claim 1, wherein the neat resin layer is an innermost layer of the cylindrical wall, and the thermoplastic composite material layer is an outermost layer of the cylindrical wall.

7. The tank of claim 6, wherein the innermost layer of the plurality of neat resin films is formed into a shape that matches the cylindrical mandrel, and wherein the outermost layer of the plurality of neat resin films is consolidated with an innermost film of the plurality of fiber-reinforced composite tape layer.

8. The tank of claim 1, wherein the neat resin layer is an outermost layer of the cylindrical wall, and the thermoplastic composite material layer is an innermost layer of the cylindrical wall.

9. The tank of claim 8, wherein the innermost layer of the plurality of fiber-reinforced composite tape layers is formed into a shape that matches the cylindrical mandrel, and wherein the outermost layer of the plurality of fiber-reinforced composite tape layers is consolidated with an innermost layer of the plurality of neat resin films.

10. The tank of claim 1, wherein the thermoplastic composite material layer is a first composite material layer, and wherein the cylindrical wall further comprises a second composite material layer.

11. The tank of claim 10, wherein the second composite material layer comprises a same composite material as the first composite material layer.

12. The tank of claim 10, wherein the second composite material layer comprises a different composite material as the first composite material layer.

13. The tank of claim 10, wherein the neat resin layer is positioned between the first composite material layer and the second composite material layer.

14. The tank of claim 1, wherein the neat resin layer comprises a thickness between 0.5 mm and 2 mm.

15. The tank of claim 1, wherein the thermoplastic composite material layer comprises a thickness between 2.5 mm and 20.0 mm.

16. The tank of claim 1, wherein the composite material of the thermoplastic composite material layer comprises polyether ether ketone (PEEK), polyetherketoneketone (PEKK), polyphenylene sulfide (PPS), or polyetherimide (PEI).

17. A method of manufacturing a tank on a mandrel, the tank configured to store a cryogenic gas, the method comprising the steps of:
forming a neat resin layer on the mandrel comprising, wherein forming the neat resin layer comprises:
applying a plurality of neat resin film layers,
while applying each neat resin film layers of the plurality of neat resin film layers, consolidating each neat resin film layer with a previously applied neat resin film layer;
forming a thermoplastic composite material layer on the mandrel, wherein forming the thermoplastic composite material layer comprises:
applying a plurality of fiber-reinforced composite tape layers on a first fiber-reinforced composite tape layer,
while applying each fiber-reinforced composite tape layer of the plurality of fiber-reinforced composite tape layers, consolidating each fiber-reinforced composite tape layer with a previously applied fiber-reinforced composite tape layer;
consolidating the neat resin layer with the thermoplastic composite material layer.

18. The method of claim 17, wherein the neat resin layer and the thermoplastic composite material layer are consolidated on the mandrel.

19. The method of claim 17, wherein the thermoplastic composite material layer is formed over the neat resin layer.

20. The method of claim 19, wherein consolidating the neat resin layer and the thermoplastic composite material layer comprises consolidating an innermost fiber-reinforced composite tape layer of the plurality of fiber-reinforced composite tape layers with an outermost neat resin film layer of the plurality of neat resin film layers.

21. The method of claim 17, wherein the neat resin layer is formed over the thermoplastic composite layer.

22. The method of claim 21, wherein consolidating the neat resin layer and the thermoplastic composite material layer comprises consolidating an innermost neat resin film layer of the plurality of neat resin film layers with an outermost fiber-reinforced composite tape layer of the plurality of fiber-reinforced composite tape layers.

23. The method of claim 21, wherein the thermoplastic composite layer is a first thermoplastic composite layer, and the method further comprises forming a second thermoplastic composite layer.

24. The method of claim 23, further comprising consolidating the neat resin layer and the thermoplastic material layer so the neat resin layer is positioned between the first thermoplastic composite layer and the second thermoplastic composite layer.

25. The method of claim 24, wherein an innermost fiber-reinforced composite tape layer of the second thermoplastic composite material layer is consolidated to an outermost neat resin film layer of the plurality of neat resin film layers.
